(19) United States
(12) Patent Application Publication
(10) Pub. No.: US 2020/0050277 A1
(43) Pub. Date: Feb. 13, 2020

(54) TOUCH PANEL

(71) Applicant: AAC Technologies Pte. Ltd., Singapore city (SG)

(72) Inventors: Yao Wang, Shenzhen (CN); Kejia Liu, Shenzhen (CN); Yao Hui, Shenzhen (CN)

(21) Appl. No.: 16/530,953

(22) Filed: Aug. 2, 2019

(30) Foreign Application Priority Data
Aug. 13, 2018 (CN) 201810916306.X

(51) Int. Cl. G06F 3/01; G06F 3/041

(52) U.S. Cl. CPC G06F 3/016; G06F 3/041

(57) ABSTRACT

A touch panel is disclose in the present invention. The touch panel includes a panel body and a vibration motor mounted on the panel body for providing haptic feedback. Wherein the vibration motor is disposed at a center of the panel body, and a thickness of the panel body is gradually reduced from the center thereof toward an edge thereof. Another touch panel disclosed in the present invention includes a panel body, and a plurality of vibration motors mounted on the panel body for providing haptic feedback. Wherein the panel body includes a plurality of vibration areas, the number of the vibration areas is same as that of the vibration motors; each of the vibration motors is disposed corresponding to one vibration area and disposed at a center of the vibration area; and a thickness of the vibration area is gradually reduced from the center thereof toward an edge thereof.

### TECHNICAL FIELD

The present invention relates to a touch panel, more particularly to a touch panel having haptic feedback function.

### DESCRIPTION OF RELATED ART

At present, electronic devices, such as computers, mobile phones, and electronic photo frames are becoming more and more powerful and more intelligent. Wherein, the input device of the electronic device for user is changed from a mechanical button to a touch button, which greatly improves the ease of operation of the electronic device.

Touching a button means that the keyboard is a flat surface, and there is no actual keystroke of the conventional button, and it cannot be actually pressed. When the user presses the virtual keyboard, there would be a vibration or a sound feedback to remind the user that the button is pressed successfully. One of the advantages of the touch button is that the entire body can be made thinner, adapting to the current demand for ultra-thinness in the electronic market, so that electronic devices such as notebook computers can be designed to be lighter and thinner, and convenient for people to carry.

However, the touch buttons in the related art adopt a structure having equal thickness, the touch is very uneven, and the touch input experience and the haptic feedback experience are poor. Moreover, the touch buttons in the related art have little haptic feedback, and even if the touch button having haptic feedback, one or two simple motors are used in the touch button, the problem is that the vibration distribution is very uneven, and rapidly reduces as the distance from the motor becomes larger. As shown in FIG. 1, when the vibration motor is placed at a center, it can be clearly seen that the tactile feedback in the center and the periphery of the keyboard is very different. The motors are driven by the same motor drive signals, the response at the center is the largest, the response at the periphery is rapidly reduced to zero, and the tactile experience is very different, resulting in poor user experience.

Therefore, it is necessary to provide a new touch panel to solve the above problems.

### BRIEF DESCRIPTION OF THE DRAWINGS

Hereinafter, the figures required in the description of the embodiments will be briefly introduced, to describe the technical solutions in the embodiments of the present invention more clearly. It is evident that the figures described below are merely some of the embodiments of the present invention. For a person of ordinary skill in the art, other figures can be obtained according to these figures without applying inventive activity, in which figures:

FIG. 1 is a schematic view showing a displacement simulation result of a touch panel in the related art.

FIG. 2 is schematic cross-section view of a touch panel according to a first embodiment of the present invention.

FIG. 3 is a schematic view showing a displacement simulation result of the touch panel according to the first embodiment of the present invention.

FIG. 4 is a schematic cross-section view of the touch panel according to a second embodiment of the present invention.

FIG. 5 is a schematic cross-section view of the touch panel according to a third embodiment of the present invention.

FIG. 6 is a schematic cross-section view of the touch panel according to a fourth embodiment of the present invention.

FIG. 7 is a schematic cross-section view of the touch panel according to a fifth embodiment of the present invention.

FIG. 8 is a schematic cross-section view of the touch panel according to a sixth embodiment of the present invention.

FIG. 9A is a schematic view of the touch panel according to a seventh embodiment of the present invention, which has two motors.

FIG. 9B is a schematic view of the touch panel according to a seventh embodiment of the present invention, which has two motors.

FIG. 10A is a schematic view of the touch panel according to the seventh embodiment of the present invention, which has four motors.

FIG. 10B is a schematic view of the touch panel according to the seventh embodiment of the present invention, which has four motors.

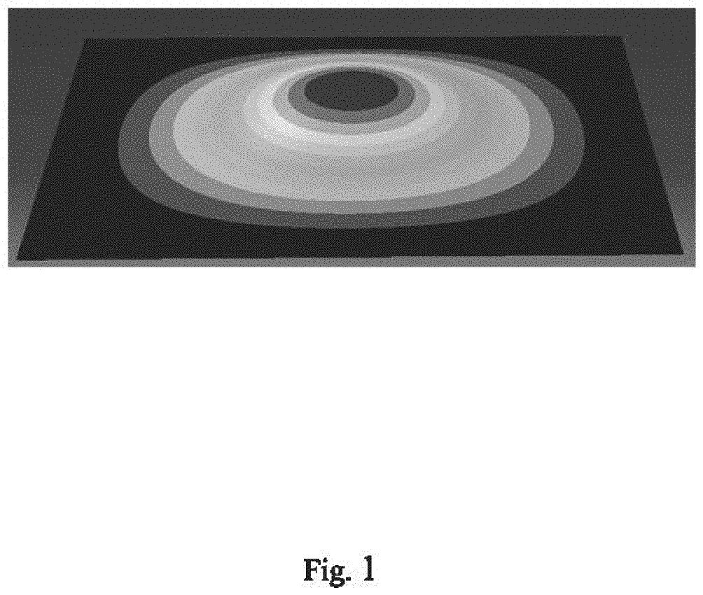

### DETAILED DESCRIPTION OF THE EXEMPLARY EMBODIMENTS

Hereinafter, technical solutions in the embodiments of the present invention will be described clearly and completely, in conjunction with the figures in the embodiments of the present invention. It is evident that the described embodiments are merely part of the embodiments of the present invention, rather than all of the embodiments. Basing on the embodiments of the present invention, all other embodiments obtained by a person of ordinary skill in the art without applying inventive activity are all within the scope of protection of the present invention.

### Exemplary Embodiment 1

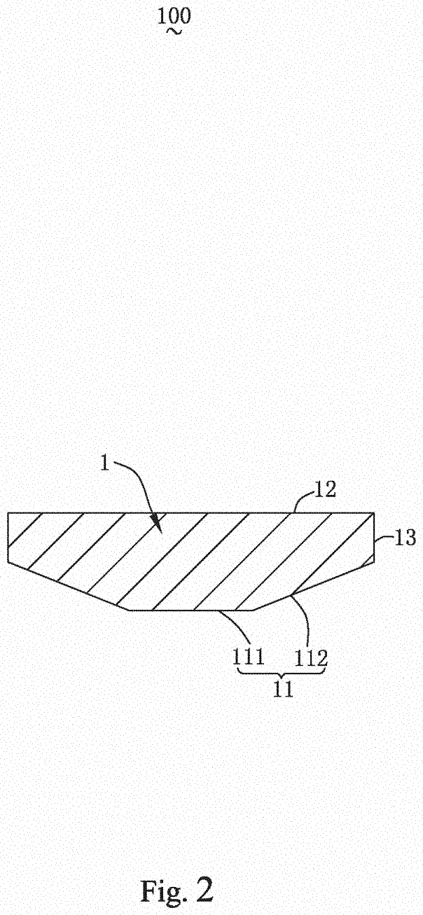

As shown in FIG. 2, a touch panel 100 according to the present invention includes a panel body 1 and a vibration motor (not shown) mounted on the panel body 1 for generating a haptic feedback. The vibration motor is disposed at a center of the panel body 1. A thickness of the panel body 1 is reduced from the center thereof to a periphery thereof (the term thickness in the present disclosure refers to a distance between a surface of the panel body close to the vibration motor and a surface of the panel body away from the vibration motor).

Specifically, the panel body 1 comprises a lower surface 11 close to the vibration motor, an upper surface 12 opposite to the lower surface 11, and a side surface 13 connected between the lower surface 11 and the upper surface 12. The vibration motor is mounted on the lower surface 11.

The lower surface 11 comprises a first surface 111 opposite to the upper surface 12 and a second surface 112 extending obliquely from the first surface 111 to the side surface 13 for connecting the first surface 111 and the side surface 112. The first surface 111 is parallel to the upper surface 12, and the vibration motor is mounted on the first surface 111.

In the embodiment, the first surface 111 is disposed at a center of the lower surface 111. The second surface 112 surrounds the first surface 111. The distance between each of edges of the first surface 111 and the side surface 113 is equal to each other. Of course, in other embodiments, the first surface 111 may be shifted to left or right (here, both left and right are in a direction shown in FIG. 2), so that the first surface 111 is disposed at a side of the lower surface 11 rather than at the center thereof, thus, the distance between each of the edges of the first surface 111 and the side surface 13 is different.

In the embodiment, the second surface 112 is flat, i.e., a thickness of the panel body 10 is changed linearly. Of course, in other embodiments, the second surface 112 may be curved rather than flat.

In the embodiment, there is one vibration motor, and such vibration motor is disposed at the center of the first surface 111. Of course, in other embodiments, the number of the vibration motor can be arbitrarily set based on actual requirements. At the same time, the panel body 1 may has a plurality of first surfaces 111 and second surfaces 112 to match the plurality of the vibration motors, so that users have a good haptic feedback experience when they touched each area of the upper surface 12.

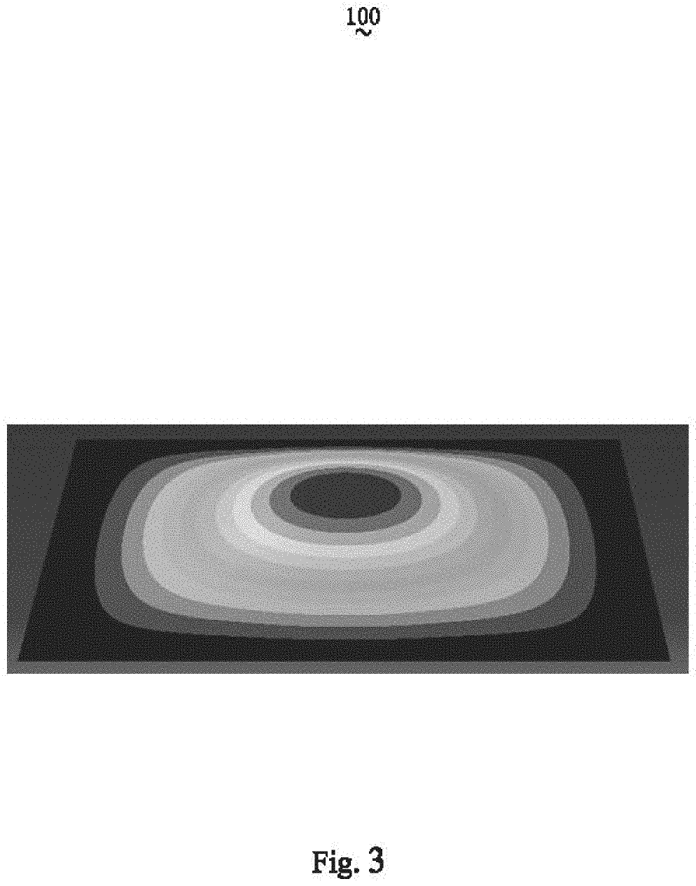

Referring to FIG. 3, it is obviously known that the panel body 1 has a multiple areas, which have different thickness, so that the response distribution area of the panel body 1 is larger, and the displacement gradient is smaller, and the distribution is more uniform, which can provide users a more excellent haptic experience.

### Exemplary Embodiment 2

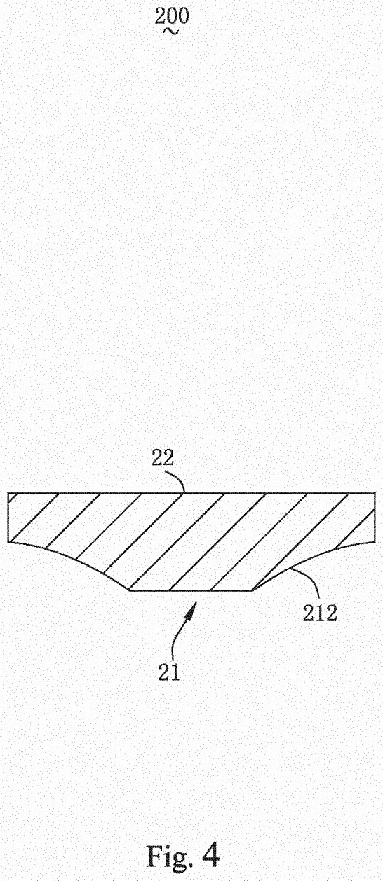

Referring to FIG. 4, the touch panel 200 is substantially same to the touch panel according to exemplary embodiment 1. However, the differences between them are recited as following:

In this embodiment, the second surface 212 is curved rather than flat, and a center of the curved second surface 212 is disposed at a side of the lower surface 21, i.e., the second surface 212 in the embodiment is a concave curved surface, which is recessed from a side of the lower surface 21 toward a side of the upper surface 22.

### Exemplary Embodiment 3

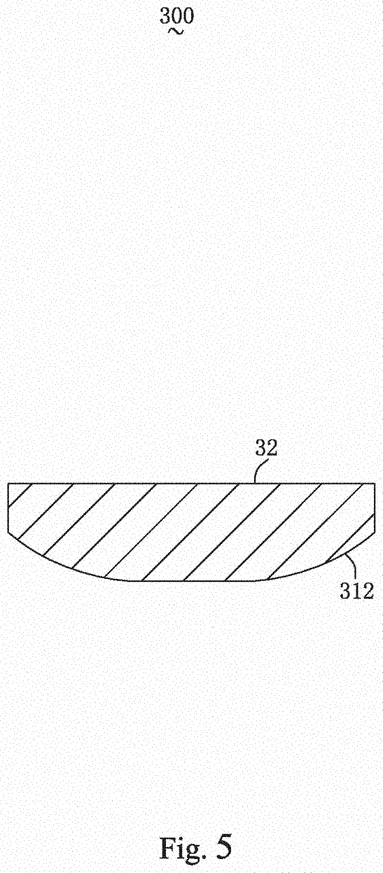

Referring to FIG. 5, the touch panel 300 is substantially same to the touch panel according to exemplary embodiment 2. However, the differences between them are recited as following:

In this embodiment, a center of the second surface 312 is disposed at a side of the upper surface 32, i.e., the second surface 312 is a convex curved surface.

### Exemplary Embodiment 4

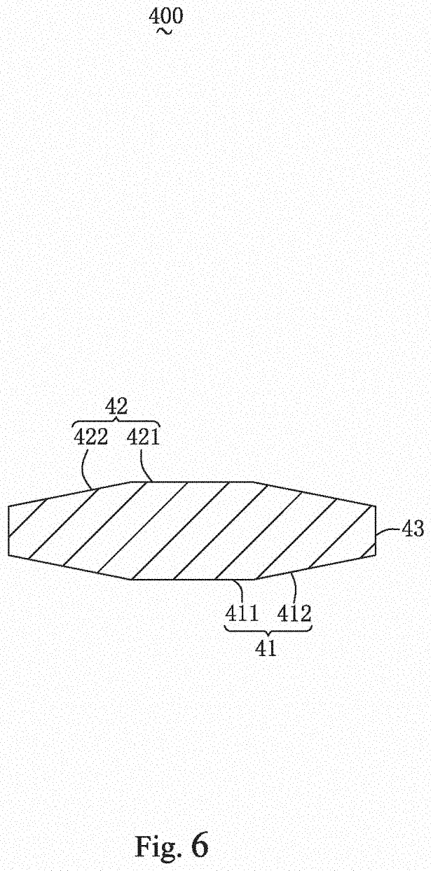

Referring to FIG. 6, the touch panel 400 is substantially same to the touch panel according to exemplary embodiment 1. However, the differences between them are recited as following:

In this embodiment, the upper surface 42 comprises a third surface 421 opposite to the lower surface 41 and a fourth surface 422 extending obliquely from the third surface 421 toward the side surface 43 for connecting the third surface 421 and the side surface 43. The third surface 421 is corresponding to the first surface 411, and the fourth surface 422 is corresponding to the second surface 412. An orthographic projection of the third surface 421 projected onto the first surface 411 overlaps with the first surface 411. An orthographic projection of the fourth surface 422 projected onto the second surface 412 overlaps with the second surface 412.

In this embodiment, a peripheral edge of the lower surface 41 and a peripheral edge of the upper surface 42 are both inclined in opposite directions so that a distance between the peripheral edge of the lower surface 41 and the edge of the upper surface 42 is smaller to reduce the thickness thereof.

It should be understand that the fourth surface 422 is flat surface in the embodiment, and surrounds a peripheral edge of the third surface 421. Of course, in other embodiment, the fourth surface 422 may be curved surface, such as the second surface 212 recited in exemplary embodiment 2, and second surface 312 recited in the exemplary embodiment 3.

### Exemplary Embodiment 5

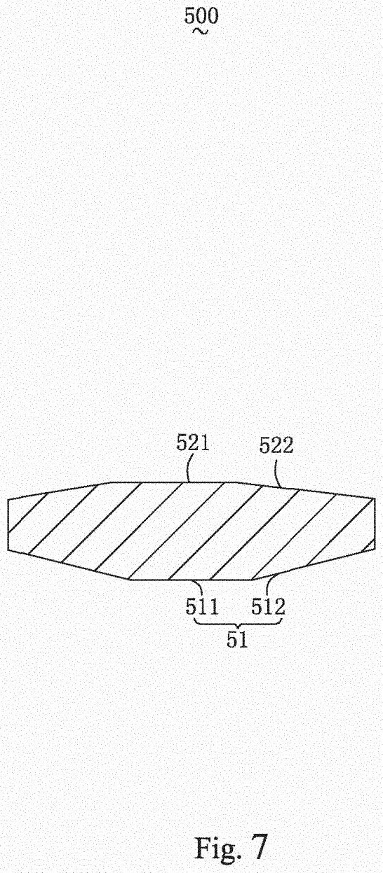

Referring to FIG. 7, the touch panel 500 is substantially same to the touch panel according to exemplary embodiment 4. However, the differences between them are recited as following:

In this embodiment, the third surface 521 is offset from the first surface 511, i.e., at least a part of an orthographic projection of the third surface 521 projected onto the first surface 511 is outside of the first surface 511, at least part of an orthographic projection of the fourth surface 522 is outside of the second surface 512, so that the distance between each of the edges of the third surface 521 and the lower surface 51 is different, which may provide more possibilities for the distribution of key positions.

### Exemplary Embodiment 6

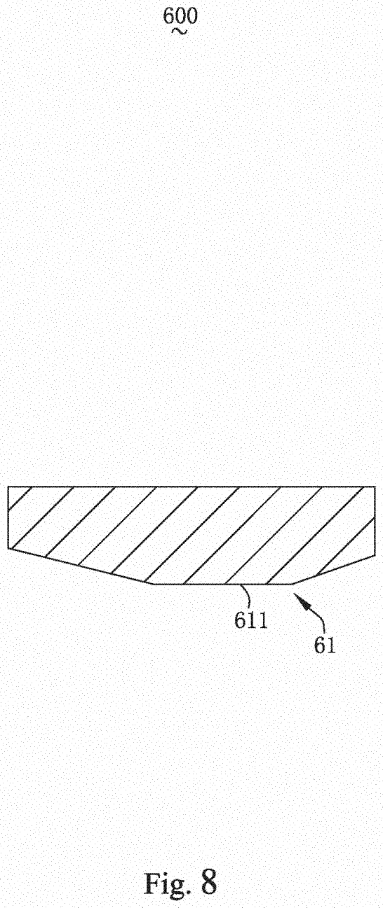

Referring to FIG. 8, the touch panel 600 is substantially same to the touch panel according to exemplary embodiment 1. However, the differences between them are recited as following:

In this embodiment, the first surface 611 is disposed at a right side of a center of the lower surface 61, rather than at the center of the lower surface 61, so that thicknesses of the edges of the touch panel 600 are different. The thickness of the edge of the touch panel 600 close to the first surface 611 is thicker, and the thickness of the edge of the touch panel 600 far away from the first surface 611 is thinner, which may provide more possibilities for the distribution of key positons.

### Exemplary Embodiment 7

Another touch panel 700 is provided in the present invention. The touch panel 700 comprises a panel body 710 and a plurality of vibration motors 720 mounted on the panel body 710. The panel body 710 has a plurality of vibration areas 711, of which the number is the same as that of the vibration motors 720. Each vibration motor 720 is positioned at a center of the vibration area 711. A thickness of the vibration area 711 gradually decreases from the center of the area toward the edge of the area.

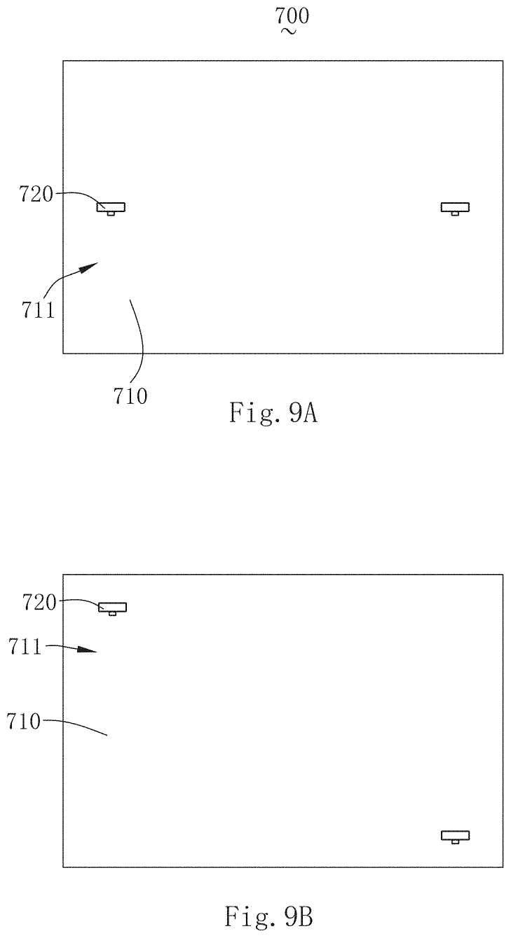

Referring to FIG. 9A and FIG. 9B, specifically, there are two vibration motors 720. Two vibration motors 720 are symmetrically arranged with respect to a center of the panel body 710.

Two vibration motors 720 can be selected according to actual requirements. For example, as shown in FIG. 9A, two vibration motors 720 are symmetrically arranged with respect to a center of the panel body 710, and distributed on the panel body 710 in a longitudinal direction of the panel body 710. The two vibration motors 720 divide the panel body 710 along parallel line in the longitudinal direction to form two vibration areas 711, and a thickness of each of the vibration area 711 gradually decrease from a position close to the vibration motor 720 toward a position away from the vibration motor 720. As shown in FIG. 9B, the two vibration motors 720 are symmetrically arranged with respect to a center of the panel body 710, and distributed on the panel body 710 in a diagonal direction of the panel body 710. The two vibration motors 720 divide the panel body 710 along diagonal line in the diagonal direction to form two vibration areas 711, and a thickness of each of the vibration area 711 gradually decreases from a position close to the vibration motor 720 toward a position away from the vibration motor 720.

The haptic feedback of the touch panel 700 can be enhanced by providing the two vibration motors 720, and the feedback efficiency of the touch panel 700 can also be enhanced.

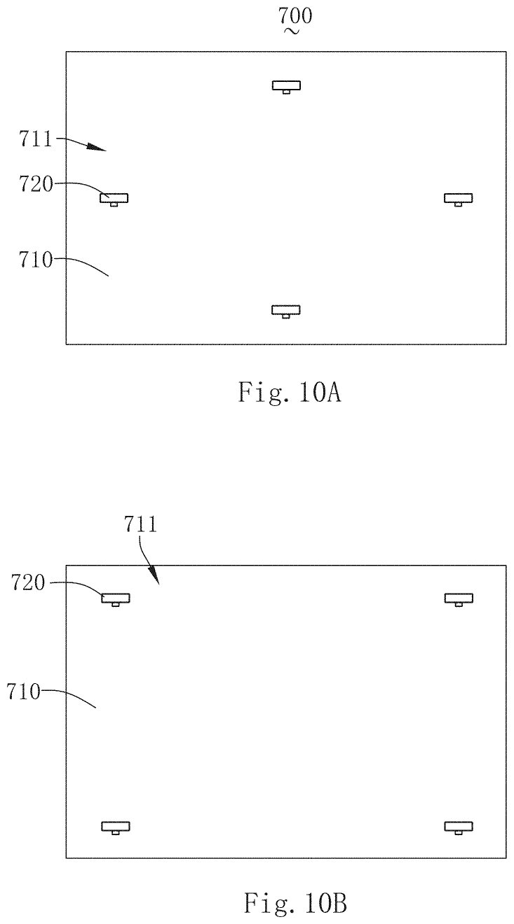

Referring to FIG. 10A and FIG. 10B, specifically, there are four vibration motors 720. The four vibration motors 720 are arranged in array with respect to the center of the panel body 710.

The four vibration motors 720 may be selected according to actual requirement. For example, as shown in FIG. 10A, the four vibration motors 720 are arranged in the panel body 710 in array. The four vibration motors 720 are respectively disposed corresponding to one side of the panel body 710. The four vibration motors 720 divide the panel body 710 into four vibration areas 711. The thickness of each of the vibration areas 711 is gradually reduced from a position close to the vibration motor 720 toward a position away from the vibration motor 720. As shown in FIG. 10B, the four vibration motors 720 are arranged in the panel body 710 in array. The four vibration motors 720 are respectively disposed corresponding to corresponding corner of the panel body 710. The four vibration motors 720 divide the panel body 710 into four vibration areas 711. The thickness of each of the vibration areas 711 is gradually reduced from a position close to the vibration motor 720 toward a position away from the vibration motor 720.

It should be noted that, to some extent, the vibration area 711 in this embodiment is the panel body recited in any one of exemplary embodiment 1 through exemplary embodiment 6, i.e., a structure of the vibration area, to some extent, is same as that of panel body recited in any one of exemplary embodiment 1 through exemplary embodiment 6.

It should be understand that, the number of the vibration motors is not limited, and can be selected according to actual requirements. At the same time, the panel body may have a plurality of first surfaces corresponding to the vibration motors and a plurality of second surfaces so that the thicknesses of each area are different, thus, the difference in haptic sensation in different areas is small, thereby improve the users' experience.

Meanwhile, it should be noted that, the touch panel provided in the present invention can be used for a notebook virtual keyboard, and can also be used for other panels, such as a display panel, a display screen of a car center console, a display screen of a smart home, and the like. That is, the object that needs to generate haptic feedback can adopt the touch panel provided in the present invention.

Compared with the related art, the touch panel provided by the present invention has a plurality of areas which have different thicknesses, the thickness of the area of the panel body close to the vibration motor is thicker, and the thickness of the area of the panel body away from the vibration motor is thinner, so that the haptic feedback equalized in each area of the panel body, when the vibration motors are driven by the same motor drive signals, the difference of the tactile feedback of each area on the panel body is small, which improves the user's tactile experience.

The above are only the embodiments of the present invention, but not limit to the patent scope of the present invention, and equivalent structures or equivalent process transformations made by utilizing the present invention and the contents of the drawings, or directly or indirectly applied to other related technical fields, are all included in the scope of the patent protection of the present invention.

What is claimed is:

1. A touch panel, comprising:
a panel body;
a vibration motor mounted on the panel body for providing haptic feedback ;
wherein, the vibration motor is disposed at a center of the panel body, and a thickness of the panel body is gradually reduced from the center thereof toward an edge thereof.

2. The touch panel according to claim 1, wherein the panel body comprises a lower surface close to the vibration motor, an upper surface opposite to the lower surface, and a side surface connected the lower surface to the upper surface; the vibration motor is mounted on the lower surface.

3. The touch panel according to claim 2, wherein the lower surface comprises a first surface opposite to the upper surface and a second surface extending obliquely from the first surface toward the side surface and connected between the first surface and the side surface; the vibration motor is mounted on the first surface.

4. The touch panel according to claim 3, wherein the second surface is flat surface or curved surface.

5. The touch panel according to claim 4, wherein the first surface is disposed at a center of the lower surface.

6. The touch panel according to claim 3, wherein the upper surface comprises a third surface opposite to the lower surface and a fourth surface extending obliquely from the third surface toward the side surface and connected between the third surface and the side surface, the third surface is disposed corresponding to the first surface, and the fourth surface is disposed corresponding to the second surface.

7. A touch panel, comprising:
a panel body,
a plurality of vibration motors mounted on the panel body for providing haptic feedback;
wherein the panel body comprises a plurality of vibration areas, the number of the vibration areas is same as that of the vibration motors;
each of the vibration motors is disposed corresponding to one vibration area and disposed at a center of the vibration area; and
a thickness of the vibration area is gradually reduced from the center thereof toward an edge thereof.
